(19) United States
(12) Patent Application Publication
(10) Pub. No.: US 2026/0118042 A1
(43) Pub. Date: Apr. 30, 2026

(54) REFRIGERATOR

(71) Applicant: SAMSUNG ELECTRONICS CO., LTD., Suwon-si (KR)

(72) Inventors: Dongyeong KIM, Suwon-si (KR); Changgu KANG, Suwon-si (KR); Byoungmok KIM, Suwon-si (KR); Hooijoong KIM, Suwon-si (KR); Jinhyun PARK, Suwon-si (KR); Huido PARK, Suwon-si (KR); Yongseop HYUN, Suwon-si (KR); Naeun OH, Suwon-si (KR); Sangjin LEE, Suwon-si (KR)

(73) Assignee: SAMSUNG ELECTRONICS CO., LTD., Suwon-si (KR)

(21) Appl. No.: 19/413,635

(22) Filed: Dec. 9, 2025

Related U.S. Application Data
(63) Continuation of application No. PCT/KR2025/014355, filed on Sep. 16, 2025.

(30) Foreign Application Priority Data
Oct. 29, 2024 (KR) 10-2024-0150169
Jul. 15, 2025 (KR) 10-2025-0095126

(51) Int. Cl. F25D 21/04; H05B 1/02

(52) U.S. Cl. CPC F25D 21/04; H05B 1/0252; F25D 2323/021; F25D 2400/06; F25D 2400/40; H05B 2203/016

(57) ABSTRACT

A refrigerator may include a body including a compartment; a first door and second door coupled to the body, and that are rotatable to open and close a first and second region of the compartment, respectively; a rotation guide including a first electrode to receive power from the body; a rotating bar on the first door, that is rotatable, and includes a heater and a second electrode to supply power to the heater, wherein, with the second region closed by the second door, as the first door closes the first region, rotation of the rotating bar is guided by the rotation guide such that, the rotating bar covers a gap between the first and second door, and with the first region closed by the first door, the first and second electrode contact such that the heater is powered by the power from the body.

### CROSS-REFERENCE TO RELATED APPLICATIONS

This is a continuation application, under 35 U.S.C. § 111 (a), of International Application PCT/KR2025/014355, filed Sep. 16, 2025, which claims priority under 35 U.S.C. § 119 to Korean Patent Application No. 10-2024-0150169, filed Oct. 29, 2024 and Korean Patent Application No. 10-2025-0095126, filed Jul. 15, 2025, in the Korean Intellectual Property Office, the disclosures of which are incorporated herein in their entireties by reference.

### TECHNICAL FIELD

The disclosure to a refrigerator having a rotating bar.

### BACKGROUND ART

A refrigerator is a home appliance for keeping food fresh, including a main body having a storage compartment, a cold air supply device for supplying cold air to the storage compartment to maintain an internal temperature of the storage compartment lower than an external temperature, and a door for opening and closing the storage compartment.

In general, the storage compartment is formed with an open front for placing and removing food products, and the open front of the storage compartment is sealed or opened by the door. To prevent cold air in the storage compartment from leaking to the outside or warm air from outside from entering the storage compartment, the door serves to seal the storage compartment.

The refrigerator may include various types of doors, for example, a French door type refrigerator in which a left door and a right door are installed together. The French door type refrigerator may include a rotating bar rotatably coupled to the left door or the right door to block a gap between the left door and the right door.

The rotating bar may have a built-in heater inside its interior to prevent dew condensation due to a temperature difference that occurs when the door is opened or closed. To supply power to such a heater, a wire may extend from a main body of the refrigerator to an inside of the rotating bar via a hinge portion of the door.

However, a power supply method using a wire requires a structure for receiving the wire inside the rotating bar, which complicates the internal structure, and securing a wire receiving space may degrade insulation performance. In addition, durability issues, such as wire sheath damage or breakage due to the repetitive opening and closing of the door, as well as a risk of electric shock.

### DISCLOSURE

### Technical Problem

An embodiment of the present disclosure provides a refrigerator capable of supplying power to a heater of a rotating bar without a wire extending from a main body into a door.

An embodiment of the present disclosure provides a refrigerator with improved insulation performance and a simplified structure by eliminating the need for a separate configuration or structure for wire withdrawal inside the door.

An embodiment of the present disclosure provides a refrigerator in which a first electrode of a rotation guide and a second electrode of a rotating bar are configured to contact each other when a door is closed, and power is supplied to a heater of the rotating bar by the contact between the first electrode and the second electrode.

Technical tasks to be achieved in this document are not limited to the technical tasks mentioned above, and other technical tasks not mentioned will be clearly understood by those skilled in the art from the description below.

### Technical Solution

In accordance with the present disclosure a refrigerator may include: a main body including a storage compartment; a first door coupled to the main body, and that is rotatable with respect to the main body to open and close a first region of the storage compartment; a second door coupled to the main body, and that is rotatable with respect to the main body to open and close a second region of the storage compartment; a rotation guide on the main body, and including a first electrode configured to receive power from the main body; a rotating bar coupled to the first door and that is rotatable with respect to the first door, the rotating bar including a heater and a second electrode configured to supply power to the heater, wherein, the rotating bar and the rotation guide may be configured to, with the second region closed by the second door, as the first door closes the first region, a rotational movement of the rotating bar may be guided by the rotation guide such that, a gap between the first door and the second door may be covered by the rotating bar, and with the first region closed by the first door, the first electrode contacts the second electrode and the power received by the first electrode may be supplied to the second electrode such that the heater may be powered by the power from the main body.

With the first region closed by the first door, the first electrode and the second electrode may contact each other.

With the first region opened by the first door, the second electrode may not contact the first electrode and the power received by the first electrode may be thereby prevented from being supplied to the second electrode such that the heater may not be powered by the power from the main body.

The first electrode may include: a first positive electrode, and a first negative electrode spaced apart from the first positive electrode, the second electrode may include: a second negative electrode, and a second positive electrode spaced apart from the second negative electrode, and the first electrode and the second electrode may be configured such that, with the first region closed by the first door, the second negative electrode contacts the first positive electrode and the second positive electrode contacts the first negative electrode.

The rotating bar may include a cap that protrudes upwardly from an upper surface of the rotating bar, and the cap may be rotatable with rotation of the rotating bar with respect to the first door, and the second electrode may be on an upper surface of the cap.

The rotation guide may include a guide groove into which the cap may be insertable, and the guide groove may be configured to: as the first door closes the first region, the cap may be inserted into the guide groove thereby causing the cap to rotate, and the rotational movement of the rotating bar may be caused by the cap being rotated, and as the first door opens the first region, the cap may be removed from the guide groove thereby causing the cap to rotate, and the rotational movement of the rotating bar may be caused by the cap being rotated.

The first electrode may be on an upper surface of the guide groove.

The rotation guide may include: an electrode groove on an upper surface of the guide groove, a moving member in the electrode groove and coupled to the first electrode such that the moving member and the first electrode may be movable together, and an elastic member configured to elastically bias the moving member upward.

The moving member may include a magnetic material, the rotating bar may include a magnet inside the cap, and with the first region closed by the first door, the moving member may be moved toward the cap by a magnetic attraction between the magnetic material and the magnet which thereby causes the first electrode to contact the second electrode.

The moving member may be movable between a first position where the moving member may be elastically biased upward by the elastic member and a second position where the moving member may be moved downward by the magnetic attraction between the magnetic material and the magnet.

With the moving member at the first position, a lower end of the first electrode may be inside the electrode groove so as not to be exposed in the guide groove.

The rotation guide may include: an electrode groove on an upper surface of the guide groove, a connecting member including: a first portion inside the electrode groove, and a second portion that protrudes outside the electrode groove so as to be exposed in the guide groove, and a shaft extended between the connecting member and the electrode groove and configured such that the first portion may be movable within the electrode groove.

The connecting member may be rotatable about the shaft, with the connecting member rotated in a first direction, the first portion may contact the first electrode, and with the connecting member rotated in a second direction, the first portion may be spaced apart from, so as not to be in contact with, the first electrode.

With the first region closed by the first door, the connecting member may be rotated by the second electrode such that the first portion contacts the first electrode and the second portion contacts the second electrode, and with the first portion in contact with the first electrode and the second portion in contact with the second electrode, the power received by the first electrode may be supplied to the second electrode such that the heater may be powered by the power from the main body.

As the first door opens the first region, the connecting member may rotate about the shaft by gravity, and the first portion may become spaced apart from, so as not to be in contact with, the first electrode.

### DESCRIPTION OF DRAWINGS

FIG. 1 illustrates a state in which a door of a refrigerator is opened according to an embodiment.

FIG. 2 is an enlarged view of portion A of FIG. 1 from a different angle.

FIG. 3 is an enlarged view of an upper portion of a rotating bar of the refrigerator according to an embodiment.

FIG. 4 is a cross-sectional view of a rotation guide shown in FIG. 2, illustrating a state in which a first electrode is positioned at a first position.

FIG. 5 is a cross-sectional view of the rotation guide shown in FIG. 2, illustrating a state in which the first electrode is positioned at a second position.

FIG. 6 illustrates a state in which a cap of the rotating bar is inserted into a guide groove of the rotation guide as a first door is closed, in a refrigerator according to an embodiment.

FIG. 7 illustrates a state in which the first electrode of the rotation guide and a second electrode of the rotating bar are in contact when the first door is closed, in the refrigerator according to an embodiment.

FIG. 8 is an enlarged view of the rotation guide of the refrigerator according to an embodiment.

FIG. 9 illustrates a state in which a connecting member of the rotation guide shown in FIG. 8 has rotated.

FIG. 10 conceptually illustrates a state in which the first electrode of the rotation guide and the second electrode of the rotating bar are electrically connected through the connecting member when the first door is closed, in the refrigerator according to an embodiment.

### DETAILED DESCRIPTION OF THE INVENTION

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of any element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A refrigerator according to an embodiment of the disclosure may include a main body.

The “main body” may include an inner case, an outer case positioned outside the inner case, and an insulation provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate an inside of the storage compartment from an outside of the storage compartment to maintain inside temperature of the storage compartment at appropriate temperature without being influenced by an external environment of the storage compartment. According to an embodiment of the disclosure, the insulation may include a foaming insulation. The foaming insulation may be molded by fixing the inner case and the outer case with jigs, etc. and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a foaming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulation.

The storage compartment may be maintained within an appropriate temperature range according to a purpose of use, and may include a “refrigerating compartment”, a “freezing compartment”, and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of-20 degrees Celsius to-1 degrees Celsius. The temperature conversion compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below are to be understood as representing storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulation to insulate the storage compartment in a closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

The refrigerator according to an embodiment of the disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to an embodiment of the disclosure may include a controller for controlling the refrigerator.

The “controller” may include a memory for storing and/or recording data and/or programs for controlling the refrigerator, and a processor for outputting control signals for controlling the cold air supply device, etc. in accordance with the programs and/or data stored in the memory.

The memory may store or record various information, data, instructions, programs, and the like necessary for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data memorized/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with to an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, various embodiments according to the disclosure will be described in detail with reference to the accompanying drawings.

As used herein, terms such as “up-and-down direction”, “front-to-back direction”, and the like may be defined based on the drawings, and the shape and position of each element are not limited by these terms. For example, the terms “front” and “rear” below may refer to a +X direction and a −X direction shown in the drawings, respectively. The terms “up”, “upward”, “down”, and “downward” below may refer to a +Z direction and a −Z direction shown in the drawings, respectively. The terms “left” and “right” below may refer to a +Y direction and a −Y direction shown in the drawings, respectively. The term “vertical direction” below may refer to the Z direction shown in the drawings, and the term “horizontal direction” below may refer to the Y direction shown in the drawings.

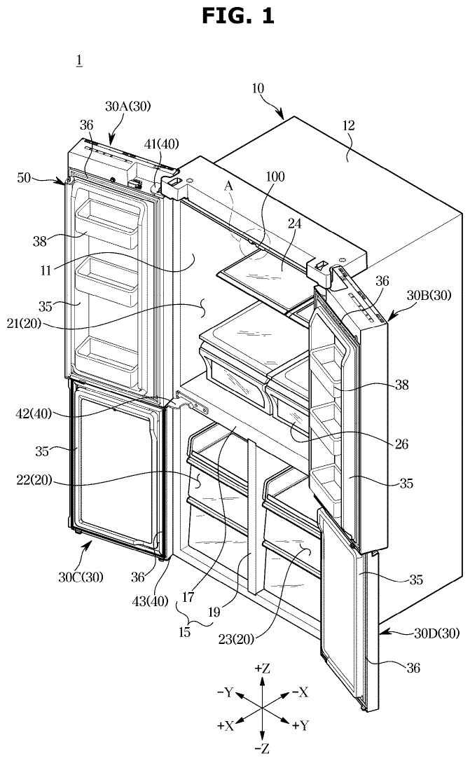

FIG. 1 illustrates a state in which a door of a refrigerator is opened according to an embodiment.

Referring to FIG. 1, a refrigerator 1 according to an embodiment may include a main body 10, a storage compartment 20 provided inside the main body 10, a door 30 configured to open or close the storage compartment 20, and a cooling system configured to supply cold air to the storage compartment 20. The cooling system may also be referred to as a cold air supply device.

The main body 10 may include an inner case 11 forming the storage compartment 20 and an outer case 12 forming an exterior of the refrigerator 1. The outer case 12 may be formed to have a box shape with a substantially open front. The outer case 12 may form an upper surface, a lower surface, left and right side surfaces, a rear surface, and the like of the refrigerator 1. The inner case 11 may have an open front. The inner case 11 may include the storage compartment 20 provided therein and may be provided inside the outer case 12. An inner wall of the inner case 11 may form an inner wall of the storage compartment 20.

A main body insulation may be provided between the inner case 11 and the outer case 12 to thermally insulate between the inner case 11 and the outer case 12. The main body insulation may be foamed between the inner case 11 and the outer case 12. The main body insulation may couple the inner case 11 and the outer case 12 to each other. The main body insulation may prevent heat exchange from occurring between an inside of the storage compartment 20 and an outside of the main body 10, thereby improving cooling efficiency inside the storage compartment 20. For example, the main body insulation may include insulations of various materials such as urethane foam insulation, expanded polystyrene (EPS) insulation, a vacuum insulation panel, and the like.

The storage compartment 20 may be formed inside the main body 10. In an example, the storage compartment 20 may include a refrigerating compartment maintained at approximately 0° C. to 5° C. for refrigerating food. In an example, the storage compartment 20 may include a freezing compartment maintained at approximately −23° C. to −17° C. for freezing food.

In various embodiments, the storage compartment 20 may be partitioned into a plurality of regions. The storage compartment 20 may be partitioned into a plurality of regions by at least one partition 15. For example, storage compartments 21, 22, and 23 may be partitioned into an upper storage compartment 21 and lower storage compartments 22 and 23 by a first partition 17 extending in a horizontal direction. In addition, the lower storage compartments 22 and 23 of the storage compartment 20 may be partitioned into a left second storage compartment 22 and a right third storage compartment 23 by a second partition 19 extending in a vertical direction. At this time, in an example, the first storage compartment 21 may be used as a refrigerating compartment, and both the second storage compartment 22 and the third storage compartment 23 may be used as freezing compartments, or one of them may be used as a freezing compartment and the other may be used as a refrigerating compartment.

The division method of the storage compartment 20 as described above and the use of each of the divided storage compartments 21, 22, and 23 are merely examples and are not limited thereto.

A shelf 24 on which food may be placed and a drawer 26 for storing food items may be provided inside the storage compartment 20.

The refrigerator 1 may include a cooling system configured to generate cold air using a cooling cycle and supply the generated cold air to the storage compartment 20. The cooling system may generate cold air using a cooling circulation cycle that compresses, condenses, expands, and evaporates a refrigerant. In an example, the cooling system may include a compressor, a condenser, an expansion valve, an evaporator, a blowing fan, and the like. Cold air generated by the cooling system may be supplied to the storage compartment 20 through a cold air supply duct formed in a rear portion of the inner case 11.

The door 30 may be configured to open or close the storage compartment 20. The door 30 may be configured to open or close an opening formed on one side of the main body 10. The door 30 may be rotatably arranged relative to the main body 10.

An outer surface of the door 30 may form a part of the exterior of the refrigerator 1. In a closed position of the door 30, the outer surface of the door 30 may form at least a portion of a front exterior of the refrigerator 1. In the closed position of the door 30, an inner surface of the door 30 may face an interior of the storage compartment 20. Herein, the inner surface of the door 30 may refer to a surface of the door 30 facing the storage compartment 20 when the door 30 closes the storage compartment 20. In addition, the outer surface of the door 30 as mentioned herein may refer to the other surface opposite to the inner surface of the door 30 facing the storage compartment 20 when the door 30 closes the storage compartment 20, and refer to a front surface of the door 30 as seen when the refrigerator 1 is viewed from the front.

A door shelf 38 capable of storing food may be provided on the inner surface of the door 30. For example, the door shelf 38 may be supported by a dyke 35 of the door 30. The door shelf 38 may be mounted on the dyke 35 of the door 30.

A gasket 36 may be provided on the inner surface of the door 30. The gasket 36 may be configured to cover a gap between the door 30 and the main body 10 to prevent cold air in the storage compartment 20 from escaping.

The refrigerator 1 may include an upper door and a lower door arranged aligned with, i.e., side by side in a vertical direction Z. The refrigerator 1 may include a left door and a right door arranged side by side in a horizontal direction Y. The refrigerator 1 may include a plurality of doors 30A, 30B, 30C, and 30D configured to open or close the partitioned storage compartments 21, 22, and 23, respectively.

The first storage compartment 21 may be opened and closed by a pair of upper doors 30A and 30B. The refrigerator 1 may include a first door 30A to open or close one portion of the first storage compartment 21 and a second door 30B to open or close the other portion of the first storage compartment 21. The first door 30A may be configured to open or close a first region of the first storage compartment 21. The second door 30B may be configured to open or close a second region of the first storage compartment 21. The first storage compartment 21 may be opened or closed by the first and second doors 30A and 30B.

The first and second doors 30A and 30B may be configured to be independently rotatable with respect to the main body 10. The first and second doors 30A and 30B may be arranged side by side in the horizontal direction (Y direction). In an example, the first door 30A may be configured to open or close a left portion of the first storage compartment 21, and the second door 30B may be configured to open or close a right portion of the first storage compartment 21.

One of the pair of upper doors 30A and 30B may be provided with a rotating bar 50 rotatably provided with respect to the one door and configured to cover a gap between the pair of upper doors 30A and 30B when the pair of upper doors 30A and 30B close the first storage compartment 21. For example, the rotating bar 50 may be rotatably arranged on the first door 30A. Hereinafter, a case where the rotating bar 50 is coupled to the first door 30A will be described as an example. As described above, the rotating bar 50 may be rotatably arranged not only on the first door 30A but also on the second door 30B.

On an upper surface 21a of the first storage compartment 21, a rotation guide 100 may be provided to guide the rotating bar 50 to rotate with respect to the first door 30A when the first door 30A is opened or closed. The rotation guide 100 may be provided at a front end of the upper surface 21a of the first storage compartment 21. The rotation guide 100 may be provided at a central portion of the upper surface 21a of the first storage compartment 21.

The second storage compartment 22 may be opened or closed by a left lower door 30C. The refrigerator 1 may include a third door 30C configured to open or close the second storage compartment 22. The third door 30C may be rotatably arranged relative to the main body 10. In an example, the first door 30A and the third door 30C may be arranged side by side in the vertical direction Z.

The third storage compartment 23 may be opened or closed by a right lower door 30D. The refrigerator 1 may include a fourth door 30D configured to open or close the third storage compartment 23. The fourth door 30D may be rotatably arranged relative to the main body 10. In an example, the second door 30B and the fourth door 30D may be arranged side by side in the vertical direction Z. In addition, the third door 30C and the fourth door 30D may be arranged side by side in the horizontal direction Y.

The structure and/or features of the door 30 described below may be applied correspondingly to each of the plurality of doors 30A, 30B, 30C, and 30D.

The refrigerator 1 may include a hinge 40 connecting the main body 10 and the door 30. The hinge 40 may be coupled to the main body 10 and the door 30, respectively. The hinge 40 may be configured such that the door 30 is rotatable relative to the main body 10. The hinge 40 may be coupled to the outer case 12. The door 30 may be rotatably coupled to the main body 10 by the hinge 40.

The refrigerator 1 may include a plurality of hinges 41, 42, and 43 configured to support the plurality of doors 30A, 30B, 30C, and 30D, respectively. For example, the refrigerator 1 may include a pair of upper door hinges 41 coupled to an upper portion of the main body 10 and configured to rotatably support the first and second doors 30A and 30B, respectively. For example, the refrigerator 1 may include a pair of lower door hinges 43 coupled to a lower portion of the main body 10 and configured to rotatably support the third door 30C and the fourth door 30D, respectively. For example, the refrigerator 1 may include a pair of middle hinges 42 disposed between the upper door hinge 41 and the lower door hinge 43, coupled to an intermediate portion of the main body 10 (particularly, to the first partition 17) to rotatably support the first door 30A, the second door 30B, the third door 30C, and the fourth door 30D, respectively.

The configurations of the refrigerator 1 described above with reference to FIG. 1 is merely an example of the present disclosure, and the present disclosure is not limited thereto. The refrigerator according to various embodiments of the present disclosure may be configured to include various configurations for performing a function of supplying cold air to a storage compartment for storing food.

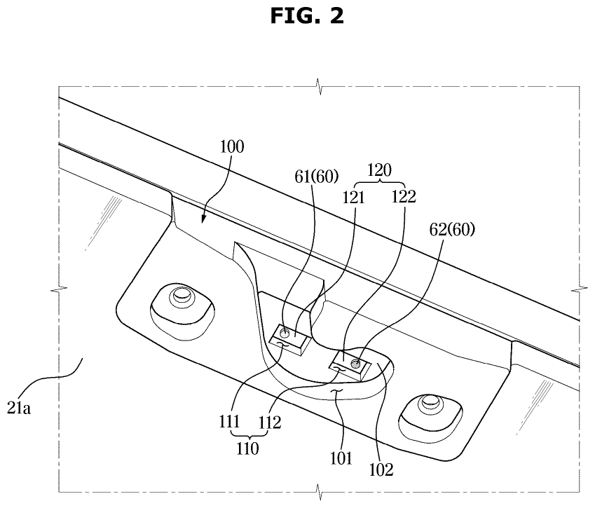

FIG. 2 is an enlarged view of portion A of FIG. 1 from a different angle.

Referring to FIG. 2, the rotation guide 100 according to an embodiment may be configured to guide rotational movement of the rotating bar 50 when the first door 30A is opened or closed. The rotation guide 100 may be disposed in the storage compartment 20 formed by the main body 10. Specifically, the rotation guide 100 may be provided on the upper surface 21a of the first storage compartment 21, which is opened or closed by the first and second doors 30A and 30B. The rotation guide 100 may be disposed at a front end of a central portion of the upper surface 21a of the first storage compartment 21.

The rotation guide 100 may include a guide groove 101 into which a cap 52 of the rotating bar 50 is inserted and configured to guide movement of the cap 52. The guide groove 101 may guide the cap 52 of the rotating bar 50 to rotate in response to closing the first door 30A. The guide groove 101 may be formed by recessing a portion of a lower surface of the rotation guide 100.

The rotation guide 100 may include an electrode groove 110 formed on an upper surface 102 of the guide groove 101. The electrode groove 110 may be formed on the upper surface 102 of the guide groove 101. The electrode groove 110 may be formed by recessing a portion of the upper surface 102 of the guide groove 101.

The electrode groove 110 may be provided with a first electrode 60 and a moving member 120 configured to move together with the first electrode 60. The moving member 120 may be configured to be movable in an up-and-down direction within the electrode groove 110. At least a portion of the first electrode 60 may pass through the moving member 120 and protrude below the moving member 120.

The electrode groove 110 may include a first electrode groove 111 and a second electrode groove 112. The first electrode groove 111 and the second electrode groove 112 may be spaced apart from each other. The moving member 120 may include a first moving member 121 and a second moving member 122. The first moving member 121 may be inserted into the first electrode groove 111. The second moving member 122 may be inserted into the second electrode groove 112.

The first electrode 60 may be electrically connected to a power supply portion provided inside the main body 10. By being electrically connected to the power supply portion, power may be applied to the first electrode 60. The power supply portion provided in the main body 10 may be electrically connected to a power source outside the refrigerator 1. The first electrode 60 may be configured to supply power to a second electrode 70, which will be described later, by contacting the second electrode 70. The first electrode 60 may include a first positive electrode 61 and a first negative electrode 62, which are spaced apart from each other.

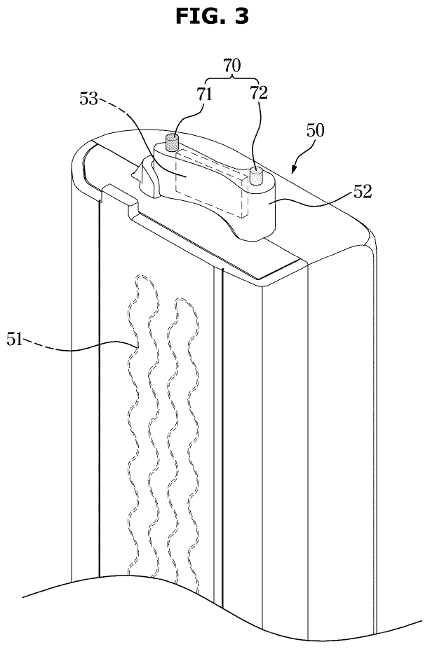

FIG. 3 is an enlarged view of an upper portion of the rotating bar of the refrigerator according to an embodiment.

Referring to FIG. 3, the rotating bar 50 according to an embodiment of the present disclosure may include a heater 51 provided therein. The heater 51 may prevent a condensation phenomenon that may occur when the first and second doors 30A and 30B are in a closed state. The heater may raise a surface temperature of the rotating bar 50 to suppress condensation of water vapor and prevent dew formation on the front surface of the refrigerator 1.

The rotating bar 50 may include the cap 52 configured to protrude upwardly from an upper surface of the rotating bar 50. The cap 52 may be configured to be movable in the up-and-down direction within a predetermined range relative to the upper surface of the rotating bar 50. The cap 52 may be elastically biased upwardly by an elastic member provided inside the rotating bar 50.

According to an embodiment, a magnet 53 may be provided inside the cap 52. The magnet 53 may attract the moving member 120 including a magnetic material by magnetic attraction. A magnetic attraction of the magnet 53 may be configured to be stronger than an elastic force of an elastic member 130, which will be described later.

The second electrode 70 may be provided on an upper surface of the cap 52. The second electrode 70 may protrude upwardly from the upper surface of the cap 52. The second electrode 70 may include a second negative electrode 71 and a second positive electrode 72, which are spaced apart from each other. The second negative electrode 71 may be configured to contact the first positive electrode 61. The second positive electrode 72 may be configured to contact the first negative electrode 62.

The second electrode 70 may receive power from the first electrode 60 by contacting the first electrode 60. The second electrode 70 may receive power from the first electrode 60 to supply power to the heater 51. The second electrode 70 may receive power through contact with the first electrode 60 to apply power to the heater 51.

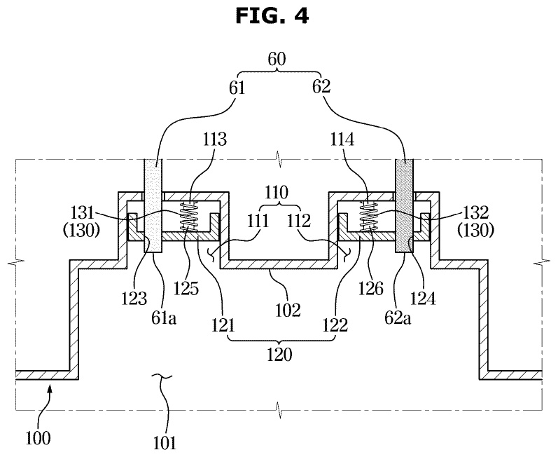

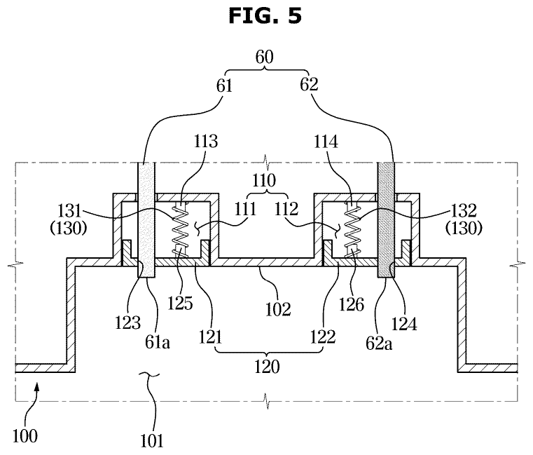

FIG. 4 is a cross-sectional view of the rotation guide shown in FIG. 2, illustrating a state in which a first electrode is positioned at a first position. FIG. 5 is a cross-sectional view of the rotation guide shown in FIG. 2, illustrating a state in which the first electrode is positioned at a second position.

Referring to FIGS. 4 and 5, the rotation guide 100 according to an embodiment may include the moving member 120 and the first electrode 60, which are movable in the up-and-down direction. The moving member 120 and the first electrode 60 may be configured to be movable between a first position and a second position. The first position may be a higher position than the second position.

According to an embodiment, the rotation guide 100 may include the elastic member 130 disposed in the electrode groove 110 and configured to elastically bias the moving member 120 upward. The elastic member 130 may include a first elastic member 131 provided in the first electrode groove 111 to elastically bias the first moving member 121 upward, and a second elastic member 132 provided in the second electrode groove 112 to elastically bias the second moving member 122 upward.

One end of the first elastic member 131 may be connected to a first support portion 113 provided on an upper surface of the first electrode groove 111. The other end of the first elastic member 131 may be connected to a second support portion 125 provided on the first moving member 121. The first elastic member 131 may elastically bias the first moving member 121 upward by being connected to the first support portion 113 and the second support portion 125. The first elastic member 131 may provide an elastic force in a direction in which the first support portion 113 and the second support portion 125 approach each other.

One end of the second elastic member 132 may be connected to a third support portion 114 provided on an upper surface of the second electrode groove 112. The other end of the second elastic member 132 may be connected to a fourth support portion 126 provided on the second moving member 122. The second elastic member 132 may elastically bias the second moving member 122 upward by being connected to the third support portion 114 and the fourth support portion 126. The second elastic member 132 may provide an elastic force in a direction in which the third support portion 114 and the fourth support portion 126 approach each other.

At least a portion of the first electrode 60 may pass through the moving member 120 and protrude below the moving member 120. To this end, the moving member 120 may have holes 123 and 124 into which the first electrode 60 is inserted.

A lower end 61a of the first positive electrode 61 may pass through the first hole 123 formed in the first moving member 121 and be located below the first moving member 121. To allow the lower end 61a of the first positive electrode 61 moving together with the first moving member 121, a diameter of the first hole 123 formed in the first moving member 121 may be configured to be equal to or smaller than an outer diameter of the first positive electrode 61. By configuring the diameter of the first hole 123 to be equal to or smaller than the outer diameter of the first positive electrode 61, the first positive electrode 61 may be press-fitted into the first hole 123. Alternatively, a groove may be formed in the first positive electrode 61 and a protrusion may be formed on the first moving member 121, such that the protrusion of the first moving member 121 may be inserted into the groove of the first positive electrode 61. Accordingly, the lower end 61a of the first positive electrode 61 may move together with the first moving member 121.

A lower end 62a of the first negative electrode 62 may pass through the second hole 124 formed in the second moving member 122 and be located below the second moving member 122. In order for the lower end 62a of the first negative electrode 62 to move together with the second moving member 122, a diameter of the second hole 124 formed in the second moving member 122 may be configured to be equal to or smaller than an outer diameter of the first negative electrode 62. By configuring the diameter of the second hole 124 to be equal to or smaller than the outer diameter of the first negative electrode 62, the first negative electrode 62 may be press-fitted into the second hole 124. Alternatively, a groove may be formed in the first negative electrode 62 and a protrusion may be formed on the second moving member 122, such that the protrusion of the second moving member 122 may be inserted into the groove of the first negative electrode 62. Accordingly, the lower end 62a of the first negative electrode 62 may move together with the second moving member 122.

Referring to FIG. 4, based on the moving member 120 being positioned at the first position, the lower ends 61a and 62a of the first electrode 60 may be disposed inside the electrode groove 110 so as not to be exposed to the guide groove 101. Based on the moving member 120 being positioned at the first position, the lower ends 61a and 62a of the first electrode 60 may be located within the electrode groove 110.

Referring to FIG. 5, based on the moving member 120 moving downwardly from the first position and being positioned at the second position, the lower ends 61a and 62a of the first electrode 60 may be exposed to the guide groove 101. Based on the moving member 120 being positioned at the second position, the lower ends 61a and 62a of the first electrode 60 may be located within the guide groove 101.

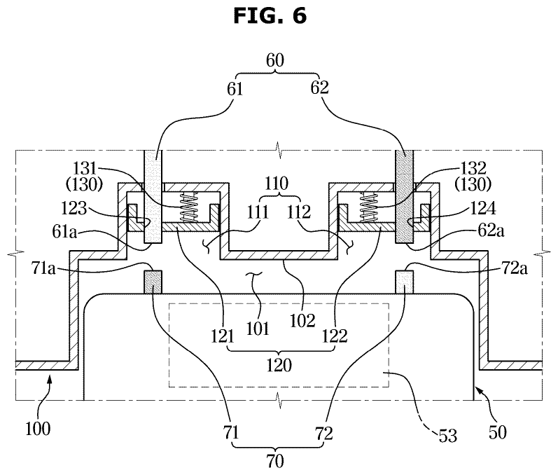

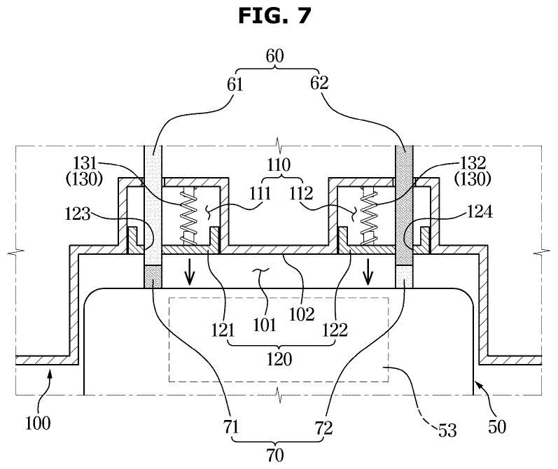

FIG. 6 illustrates a state in which a cap of the rotating bar is inserted into a guide groove of the rotation guide as a first door is closed, in the refrigerator according to an embodiment. FIG. 7 illustrates a state in which the first electrode of the rotation guide and a second electrode of the rotating bar are in contact when the first door is closed, in the refrigerator according to an embodiment.

Referring to FIGS. 6 and 7, a process in which the first electrode 60 of the rotation guide 100 and the second electrode 70 of the rotating bar 50 come into contact in response to the closing of the first door 30A, in a refrigerator according to an embodiment, will be described.

When the first door 30A is opened, the moving member 120 and the first electrode 60 may be positioned at the first position, as shown in FIG. 4. In response to the closing of the first door 30A, the cap 52 may be inserted into the guide groove 101, as shown in FIG. 6. When the cap 52 is inserted into the guide groove 101, the lower ends 61a and 62a of the first electrode 60 positioned at the first position may be spaced apart from upper ends 71a and 72a of the second electrode 70 in the up-and-down direction.

According to the present disclosure, when the first electrode 60 and the second electrode 70 are in contact with each other, power may be supplied to the heater 51, and when the first electrode 60 and the second electrode 70 are not in contact, power supply to the heater 51 may be cut off. Thus, as shown in FIG. 6, when the lower ends 61a and 62a of the first electrode 60 and the upper ends 71a and 72a of the second electrode 70 are spaced apart from each other, power may not be supplied to the heater 51.

Referring to FIGS. 6 and 7, after the cap 52 is inserted into the guide groove 101, the moving member 120 may move downward by a magnetic attraction between the magnet 53 disposed inside the cap 52 and the moving member 120 including a magnetic material. As described above, since the magnetic attraction between the magnet 53 and the moving member 120 is arranged to be larger than the elastic force of the elastic member 130, the moving member 120 may move downward by the magnetic attraction even though the moving member 120 is elastically biased upward. As the moving member 120 moves downward by the magnetic attraction between the magnet 53 and the moving member 120, the moving member 120 and the first electrode 60 may be positioned at the second position. By the magnetic attraction between the magnet 53 and the moving member 120, a state in which the first electrode 60 and the second electrode 70 are in contact may be maintained. Specifically, a state in which the first positive electrode 61 and the second negative electrode 71 are in contact, and the first negative electrode 62 and the second positive electrode 72 are in contact may be maintained. For example, the lower end 61a of the first positive electrode 61 and the upper end 71a of the second negative electrode 71 may be in contact, and the lower end 62a of the first negative electrode 62 and the upper end 72a of the second positive electrode 72 may be in contact. However, the present disclosure is not limited thereto. It is sufficient that the first electrode 60 and the second electrode 70 are in contact, and there is no limitation on a position at which the first electrode 60 and the second electrode 70 are in contact.

As the state in which the first positive electrode 61 and the second negative electrode 71 are in contact and the first negative electrode 62 and the second positive electrode 72 are in contact is maintained, power may be supplied to the heater 51 from inside the main body 10 through the first electrode 60 and the second electrode 70.

When the first door 30A is opened, the cap 52 is withdrawn from the guide groove 101, thereby increasing a gap between the magnet 53 and the moving member 120, and accordingly, the magnetic attraction may not substantially act. When the magnetic attraction does not act, the moving member 120 and the first electrode 60 may move upward by the elastic force of the elastic member 130 and be positioned at the first position. In addition, by the elastic force of the elastic member 130, a state in which the moving member 120 and the first electrode 60 are positioned at the first position may be maintained.

There is no risk of electric shock even when a user's body contacts the second electrode 70 to which power is supplied. However, there is a risk of electric shock when the user's body contacts the first electrode 60 to which power is applied. To prevent electric shock, the contact between the first electrode 60 and the user's body should be avoided. To this end, the first electrode 60 may be positioned inside the electrode groove 110 so as not to be exposed to the guide groove 101 when the first door 30A is opened. In other words, when the first door 30A is opened, the first electrode 60 may remain in a state of not being exposed to the outside by being positioned at the first position.

With such a structure described above, the refrigerator 1 according to the present disclosure may supply power to the heater 51 of the rotating bar 50 without a wire extending from the main body 10 to the inside of the door 30. In addition, the refrigerator 1 according to the present disclosure may improve insulation performance and simplify its structure by not including a separate configuration or structure for wire withdrawal inside the door 30. Furthermore, the refrigerator 1 according to the present disclosure may prevent electric shock to the user in advance by keeping the first electrode 60, to which power is applied, unexposed to the outside.

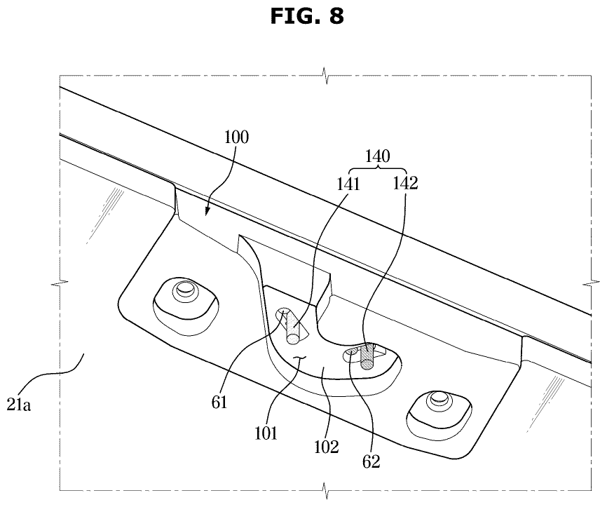

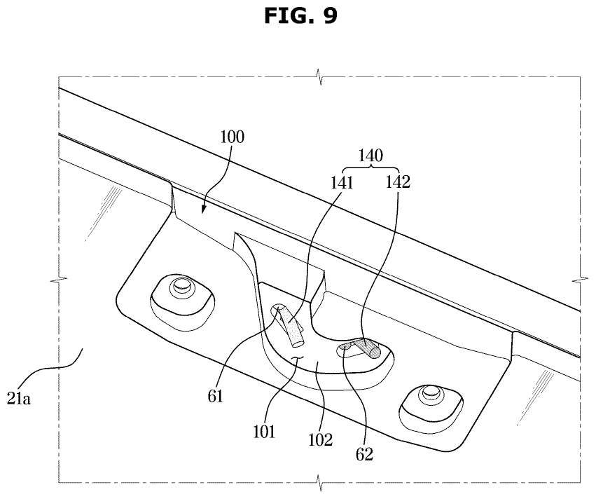

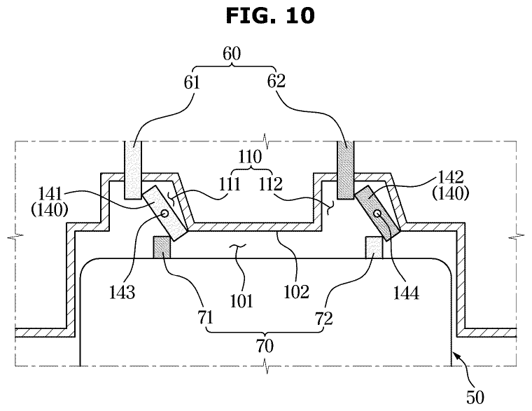

FIG. 8 is an enlarged view of the rotation guide of the refrigerator according to an embodiment. FIG. 9 illustrates a state in which a connecting member of the rotation guide shown in FIG. 8 has rotated. FIG. 10 conceptually illustrates a state in which the first electrode of the rotation guide and the second electrode of the rotating bar are electrically connected through the connecting member when the first door is closed, in the refrigerator according to an embodiment.

Hereinafter, the rotation guide 100 and the rotating bar 50 of the refrigerator according to an embodiment will be described with reference to FIGS. 8 to 10.

Referring to FIGS. 8 and 9, the rotation guide 100 according to an embodiment may include the electrode groove 110 formed on the upper surface 102 of the guide groove 101, a connecting member (e.g., a connector) 140 including a first portion disposed inside the electrode groove 110 and a second portion protruding outside the electrode groove, and shafts 143 and 144 configured to rotatably support the connecting member 140.

The first electrode 60 may be disposed inside the electrode groove 110. The first electrode 60 may be configured such that a lower end thereof does not protrude outside the electrode groove 110. In other words, the lower end of the first electrode 60 may be configured to be located within the electrode groove 110.

The connecting member 140 may be configured to be rotatable within the electrode groove 110. The connecting member 140 may be configured to be rotatable about the shafts 143 and 144. The shafts 143 and 144 may connect the connecting member 140 and a side surface of the electrode groove 110.

The connecting member 140 may be made of a conductive material. Accordingly, in response to contacting the connecting member 140 to the first electrode 60 and the second electrode 70, power may be supplied to the heater 51 from the first electrode 60 via the connecting member 140 and the second electrode 70.

The connecting member 140 may include a first connecting member 141 and a second connecting member 142, wherein at least a portion of the first connecting member 141 is disposed in the first electrode groove 111 and at least a portion of the second connecting member 142 is disposed in the second electrode groove 112.

The shafts 143 and 144 may include a first shaft 143 rotatably supporting the first connecting member 141 and a second shaft 144 rotatably supporting the second connecting member 142.

Referring to FIG. 8, when the first door 30A is opened, the connecting member 140 may be disposed vertically by gravity. When the connecting member 140 is disposed vertically, the connecting member 140 and the first electrode 60 may not be in contact. To this end, the connecting member 140 and the first electrode 60 may be disposed to be spaced apart.

When the connecting member 140 is disposed vertically by gravity, a lower end of the connecting member 140 may be positioned in the guide groove 101. Since no power is applied to the connecting member 140, the user may not receive an electric shock even when the user contacts the connecting member 140.

Referring to FIGS. 9 and 10, when the first door 30A is closed, the cap 52 may be inserted into the guide groove 101, and the second electrode 70 may move the connecting member 140. When the first door 30A is closed, the second electrode 70 may contact the connecting member 140 and rotate the connecting member 140. In other words, the second electrode 70 may push the connecting member 140 to cause the connecting member 140 to rotate. The connecting member 140 rotated by the second electrode 70 may come into contact with the first electrode 60 and the second electrode 70. As described above, when the connecting member 140 contacts the first electrode 60 and the second electrode 70, power may be supplied to the heater 51 from the first electrode 60 via the connecting member 140 and the second electrode 70.

When the first door 30A is opened, the cap 52 may be withdrawn from the guide groove 101, and accordingly, the connecting member 140 may be disposed vertically by gravity. As described above, even if the lower end of the vertically disposed connecting member 140 is located in the guide groove 101, the user may not receive an electric shock upon contact with the connecting member 140 because the connecting member 140 does not contact the first electrode 60.

With such a structure described above, the refrigerator 1 according to the present disclosure may supply power to the heater 51 of the rotating bar 50 without a wire extending from the main body 10 to the inside of the door 30. In addition, the refrigerator 1 according to the present disclosure may improve insulation performance and simplify its structure by not including a separate configuration or structure for wire withdrawal inside the door 30. Furthermore, the refrigerator 1 according to the present disclosure may prevent electric shock to the user in advance by spacing the connecting member 140 from the first electrode 60 apart when the first door 30A is opened.

The refrigerator according to an embodiment may include a main body defining a storage compartment, a first door rotatably coupled to the main body to open or close a first region of the storage compartment, a second door disposed aligned with the first door and rotatably coupled to the main body to open or close a second region of the storage compartment, a rotating bar rotatably coupled to the first door, configured to cover a gap between the first door and the second door when the first door and the second door are closed, and including a heater, a rotation guide disposed on the main body to guide rotational movement of the rotating bar when the first door or the second door is opened or closed, a first electrode disposed on the rotation guide and configured to receive power from the main body, and a second electrode disposed on the rotating bar and configured to supply power to the heater by contacting the first electrode.

When the first door is closed, the first electrode and the second electrode may be disposed to contact each other.

When the first door is opened, the second electrode may not be in contact with the first electrode, thereby cutting off power supply to the heater.

The first electrode may include a first positive electrode and a first negative electrode spaced apart from the first positive electrode.

The second electrode may include a second negative electrode configured to contact the first positive electrode, and a second positive electrode spaced apart from the second negative electrode and configured to contact the first negative electrode.

The rotating bar may include a cap configured to protrude upwardly from an upper surface of the rotating bar.

The second electrode may be disposed on an upper surface of the cap.

The rotation guide may include a guide groove into which the cap is inserted.

The guide groove may be configured to guide movement of the cap when the first door is opened or closed.

The first electrode may be disposed on an upper surface of the guide groove.

The rotation guide may include an electrode groove formed on an upper surface of the guide groove, a moving member coupled to a first electrode to be movable together with the first electrode, the moving member being inserted into the electrode groove, and an elastic member configured to elastically bias the moving member upward.

The moving member may include a magnetic material.

The rotating bar may include a magnet provided inside the cap.

In response to closing the first door, the moving member may move toward the cap by a magnetic attraction of the magnet, causing the first electrode to contact the second electrode.

The moving member may be configured to be movable between a first position elastically biased upward by the elastic member and a second position moved downward by the magnetic attraction of the magnet.

When the moving member is positioned at the first position, a lower end of the first electrode may be disposed inside the electrode groove so as not to be exposed to the guide groove.

The rotation guide may include an electrode groove formed on an upper surface of the guide groove, a connecting member including a first portion disposed inside the electrode groove and a second portion protruding outside the electrode groove and disposed in the guide groove, and a shaft provided between the connecting member and the electrode groove such that the first portion is movable within the electrode groove.

The connecting member may be configured to be rotatable about the shaft.

In response to rotation of the connecting member, the first portion is in contact or not in contact with the first electrode.

The second electrode may be configured to move the connecting member such that the first portion contacts the first electrode in response to closing the first door.

When the first door is closed, power may be supplied to the heater when the first portion contacts the first electrode and the second portion contacts the second electrode.

In response to opening the first door, the connecting member may rotate about the shaft by gravity, and the first portion and the first electrode may not be in contact.

According to the concept of the present disclosure, the refrigerator can supply power to the heater of the rotating bar without a wire extending from the main body into the door.

According to the concept of the present disclosure, the refrigerator with improved insulation performance and a simplified structure by eliminating the need for a separate configuration or structure for wire withdrawal inside the door can be provided.

According to the concept of the present disclosure, the refrigerator in which the first electrode of the rotation guide and the second electrode of the rotating bar are configured to contact each other when the door is closed, and power is supplied to the heater of the rotating bar by the contact between the first electrode and the second electrode may be provided.

Although the above technical ideas of the disclosure have been described by way of specific embodiments, the scope of the disclosure is not limited to these embodiments. Various modifications and variations that can be made by those skilled in the art without departing from the technical ideas of the disclosure as set forth in the claims of the patent will be deemed to be within the scope of the disclosure.

1. A refrigerator, comprising:
a main body including a storage compartment;
a first door coupled to the main body, and that is rotatable with respect to the main body to open and close a first region of the storage compartment;
a second door coupled to the main body, and that is rotatable with respect to the main body to open and close a second region of the storage compartment;
a rotation guide on the main body, and including a first electrode configured to receive power from the main body;
a rotating bar coupled to the first door and that is rotatable with respect to the first door, the rotating bar including a heater and a second electrode configured to supply power to the heater,
wherein, the rotating bar and the rotation guide are configured to,
with the second region closed by the second door,
as the first door closes the first region, a rotational movement of the rotating bar is guided by the rotation guide such that, a gap between the first door and the second door is covered by the rotating bar, and
with the first region closed by the first door,
the first electrode contacts the second electrode and the power received by the first electrode is supplied to the second electrode such that the heater is powered by the power from the main body.

2. The refrigerator of claim 1, wherein with the first region closed by the first door, the first electrode and the second electrode contact each other.

3. The refrigerator of claim 1, wherein with the first region opened by the first door, the second electrode does not contact the first electrode and the power received by the first electrode is thereby prevented from being supplied to the second electrode such that the heater is not powered by the power from the main body.

4. The refrigerator of claim 1, wherein
the first electrode includes:
a first positive electrode, and
a first negative electrode spaced apart from the first positive electrode, the second electrode includes:
a second negative electrode, and
a second positive electrode spaced apart from the second negative electrode, and
the first electrode and the second electrode are configured such that,
with the first region closed by the first door,
the second negative electrode contacts the first positive electrode and the second positive electrode contacts the first negative electrode.

5. The refrigerator of claim 1, wherein
the rotating bar includes a cap that protrudes upwardly from an upper surface of the rotating bar, and the cap is rotatable with rotation of the rotating bar with respect to the first door, and
the second electrode is on an upper surface of the cap.

6. The refrigerator of claim 5, wherein
the rotation guide includes a guide groove into which the cap is insertable, and
the guide groove is configured to:
as the first door closes the first region, the cap is inserted into the guide groove thereby causing the cap to rotate, and the rotational movement of the rotating bar is caused by the cap being rotated, and
as the first door opens the first region, the cap is removed from the guide groove thereby causing the cap to rotate, and the rotational movement of the rotating bar is caused by the cap being rotated.

7. The refrigerator of claim 6, wherein the first electrode is on an upper surface of the guide groove.

8. The refrigerator of claim 6, wherein
the rotation guide includes:
an electrode groove on an upper surface of the guide groove,
a moving member in the electrode groove and coupled to the first electrode such that the moving member and the first electrode are movable together, and
an elastic member configured to elastically bias the moving member upward.

9. The refrigerator of claim 8, wherein
the moving member includes a magnetic material,
the rotating bar includes a magnet inside the cap, and
with the first region closed by the first door, the moving member is moved toward the cap by a magnetic attraction between the magnetic material and the magnet which thereby causes the first electrode to contact the second electrode.

10. The refrigerator of claim 9, wherein the moving member is movable between a first position where the moving member is elastically biased upward by the elastic member and a second position where the moving member is moved downward by the magnetic attraction between the magnetic material and the magnet.

11. The refrigerator of claim 10, wherein with the moving member at the first position, a lower end of the first electrode is inside the electrode groove so as not to be exposed in the guide groove.

12. The refrigerator of claim 6, wherein
the rotation guide includes:
an electrode groove on an upper surface of the guide groove,
a connecting member including:
a first portion inside the electrode groove, and
a second portion that protrudes outside the electrode groove so as to be exposed in the guide groove, and
a shaft extended between the connecting member and the electrode groove and configured such that the first portion is movable within the electrode groove.

13. The refrigerator of claim 12, wherein
the connecting member is rotatable about the shaft,
with the connecting member rotated in a first direction, the first portion contacts the first electrode, and
with the connecting member rotated in a second direction, the first portion is spaced apart from, so as not to be in contact with, the first electrode.

14. The refrigerator of claim 13, wherein
with the first region closed by the first door,
the connecting member is rotated by the second electrode such that the first portion contacts the first electrode and the second portion contacts the second electrode, and
with the first portion in contact with the first electrode and the second portion in contact with the second electrode, the power received by the first electrode is supplied to the second electrode such that the heater is powered by the power from the main body.

15. The refrigerator of claim 13, wherein, as the first door opens the first region, the connecting member rotates about the shaft by gravity, and the first portion becomes spaced apart from, so as not to be in contact with, the first electrode.
